(19) United States
(12) Patent Application Publication
(10) Pub. No.: US 2019/0037861 A1
(43) Pub. Date: Feb. 7, 2019

(54) FERMENTED PIZZA DOUGH SNACKS

(71) Applicant: Hello Delicious Brands LLC, Northbrook, IL (US)

(72) Inventors: Kerin Kennedy, Niwot, CO (US); Mark Lindsley, McComb, OH (US)

(21) Appl. No.: 16/074,025

(22) PCT Filed: Jan. 30, 2017
(86) PCT No.: PCT/US17/15564

§ 371 Date: Jul. 30, 2018

Related U.S. Application Data
(60) Provisional application No. 62/289,758, filed on Feb. 1, 2016.

(51) Int. Cl. A21D 2/18; A21D 8/06

(52) U.S. Cl. CPC A21D 2/181; A21D 13/41; A21D 8/06

(57) ABSTRACT

A pizza dough capable of being fermented in 30-60 minutes, allowing for the mass production of pizza dough snacks, is disclosed. The dough comprises a flour, a leavening system comprising yeast and yeast extract, and a sweetener. The combination of the ingredients, in particular the sweetener and leavening system, results in a dough and final product that displays the organoleptic properties of pizza, yet the dough only has a fermentation time of about 30-60 minutes.

### CROSS-REFERENCE TO RELATED APPLICATIONS

This application claims priority to U.S. Provisional Application No. 62/289,758, filed on Feb. 1, 2016, the entire contents of which are hereby incorporated by reference.

### FIELD OF THE INVENTION

The invention relates generally to fermented dough and snacks made therefrom. More specifically, the invention relates to snacks made from pizza dough such as crackers, chips, cookies and the like.

### BACKGROUND OF THE INVENTION

Innovation in the food industry is unceasing. The combination of flavors, textures, and forms among other organoleptic properties into new platforms for the consumer is a matter of never ending research and investigation. This is especially the case with snack foods. Still, even with investigation, it is not a certainty that the modification of one food stuff into a different food product will prove palatable. The production of a food stuff which proves palatable, nutritious, and is enticing to the consumer is artistry and not just a matter of routine research and development.

Snacks are generally divided into five broad groups: baked goods, salted snacks, specialty snacks, confectionery snacks, and naturally occurring snacks. Baked goods include, but are not limited to, cookies, crackers, sweet goods, snack cakes, pies, granola/snack bars, and toaster pastries. Salted snacks include, but are not limited to, potato chips, corn chips, tortilla chips, extruded snacks, popcorn, pretzels, potato crisps, and nuts. Specialty snacks include, but are not limited to, dips, dried/fruit snacks, meat snacks, pork rinds, health food bars such as Power Bars® and rice/corn cakes. Confectionery snacks include various forms of candy. Naturally occurring snack foods include nuts, dried fruits and vegetables. Traditional snacks cut across the five groups as they comprise select species of snacks, including, but not limited to, cookies, brownies, filled crackers, snack cakes, pies, potato crisps, corn chips, tortilla chips, filled extruded snacks, enrobed extruded snacks, pretzels, spreads or dips, rice/corn cakes and confectionery snacks.

Unfortunately, numerous obstacles and technical challenges have kept the most desirable nutritionally balanced traditional snacks and mixes from the consumer. One example which illustrates the complexity of food processing to this end is the production of a pizza crust into a cracker or snack chip. Pizza dough most often is a malleable food stuff having organoleptic characteristics which provide a moist, malleable, tender consistency. Once baked, the pizza dough exhibits unique organoleptic properties such as flaky crust and distinguishing flavor notes. Many of these organoleptic properties are imparted through the fermentation process. Fermentation of pizza dough is a time-consuming process, often lasting on the order of several hours or more. See, for example, U.S. Pat. Nos. 6,083,550 and 6,764,700 and 5,747,084 and 4,539,213 among others, all of which are incorporated herein by reference. Other examples of pizza dough and crust manufacturing processes include U.S. Pat. Nos. 6,365,210 and 6,156,364 and 5,789,000, all of which are incorporated herein by reference, among others.

Snack chips and crackers often have a rigid texture with a savory character often designed to highlight or complement another food stuff with which the chip or cracker is combined. While traditionally snack chips and crackers have had long fermentation times, often on the order of 20 to 30 hours, industrialization and mechanization have motivated snack chip and cracker manufacturers to limit the fermentation times of their products. In fact, in many cracker and snack chip manufacturing processes no time is allotted for feitnentation at all. As such, among the issues that must be overcome in the production of a pizza crust into a cracker or snack chip is the fact that traditional pizza dough requires a significant leavening or fermentation time, often several hours or more, which is incompatible with the mass production of crackers or chips.

In short, it can be difficult to combine the properties of two disparate food stuffs to develop a truly pleasing product. What is needed is a dough that contains the organoleptic properties of a pizza dough, yet has a fermentation time compatible with the mass production of crackers or chips.

### SUMMARY OF THE INVENTION

The invention is a dough and finished snack food comprising a flour such as hard wheat flour, a leavening system of both active dry yeast and a yeast extract such as Lallemand LBI 2131 Powder yeast extract, a sweetener such as brown rice syrup, and various flavorings such as sea salt, garlic and oregano, and water. It has been discovered that the addition of the yeast extract, as well as the sweetener, results in a dough and finished product containing the organoleptic properties of pizza. However, unlike traditional pizza dough the fermentation time of the dough is only about 30-60 minutes, allowing the dough to be mass produced as a cracker or chip.

### BRIEF DESCRIPTION OF THE DRAWINGS

FIG. 1 is a top-down view of a representative food die used to cut dough in accordance with the present disclosure.

### DETAILED DESCRIPTION

The invention comprises a dough and food product which is in one form a snack chip. The compositions of the invention comprise a wheat flour, a leavening system, a sweetener and flavoring.

A. Flour

The invention may incorporate any number of flours useful in providing a dough of appropriate consistency. The flour material can be derived from various grain materials including, but not limited to, wheat flour such as durum, semolina and the like. It is also possible to employ other types of flour material into the dough and snack of the invention. Non-limiting examples include material derived from other cereals and grains including, but not limited to, maize, corn, rice, barley, etc. The pasta materials can include other ingredients as desired or required. The grain materials can be supplemented with starch material derived from other sources, for example potatoes and the like.

Wheat flour is a powder made from the grinding of wheat used for human consumption. More wheat flour is produced than any other flour. Wheat varieties are called “soft” or “weak” if gluten content is low, and are called “hard” or “strong” if they have high gluten content. Hard flour, or bread flour, is high in gluten, with 12% to 14% gluten content. Its dough has elastic toughness that holds its shape well once baked. Soft flour is comparatively low in gluten and thus results in a loaf with a finer, crumbly texture.

Dough compositions of the invention preferably comprise hard wheat flour and may optionally include one or more other types of flour. Suitable hard wheat flour comprises about 11% to about 15% protein and, more preferably, about 13% to 15% protein in order to provide strength and stability to developed dough compositions of the invention. Optionally, the hard wheat flour may be combined with one or more other types of flour in order to provide the composition with other desirable attributes, for example, desirable textural characteristics, nutritional values, and the like. Hard wheat flour may be obtained commercially from such sources as ADM Milling; Bay State Milling Co., Conagra Inc.; General Mills, Inc.; Horizon Milling, LLC; and Rohstein Corp.

In terms of the parts of the grain (the grass fruit) used in flour—the endosperm or protein/starchy part, the genii or protein/fat/vitamin-rich part, and the bran or fiber part—there are three general types of flour. White flour is made from the endosperm only. Brown flour includes some of the grain's germ and bran, while whole grain or whole meal flour is made from the entire grain, including the bran, endosperm, and germ. Germ flour is made from the endosperm and germ, excluding the bran.

Preferably, the various compositions of the invention comprise a hard wheat flour. The hard wheat flour is preferably a spring wheat with a protein content of 10% to 15%, and preferably 13% to 15%.

### Leavening System

The dough and food product of the invention comprise a leavening system. Leavening systems in doughs and food products serve to promote fermentation. Fermentation enriches the diet through development of a diversity of flavors, aromas and textures in food substrates. Fermentation also preserves foods with lactic acid, alcohol and acetic acid fermentations. Fermentation also provides for the enrichment of foods with protein, essential amino acids and vitamins. Fermentation also eliminates antinutrients and decreases cooking time and fuel requirements. Leavening systems useful in this invention generally comprise both live yeast and yeast extract.

The invention includes the addition of live yeast to the dough prior to baking. The term “live yeast” refers to yeast that is capable of both anaerobic fermentation of sugars into alcohol and carbon dioxide gas, and aerobic metabolism of sugars thereby consuming oxygen. Such live yeast cells can be enumerated as CFU (colony forming units) on petri dishes containing a yeast selective agar medium (YEP+chloroam-phenicol). Many yeast strains may be used in the invention including yeast strains of the genus Saccharomyces like wine and beer yeast strains, baker's yeast strains (Saccharomyces cerevisiae) and probiotic yeast strains (Saccharomyces cerevisiae var. boulardii). Most commercially available yeast is not a pure culture and may contain small amounts of lactic acid bacteria which do not affect results when used in the present invention. Both fresh yeast (block, bag or cream yeast) and dry yeast (instant dry yeast or active dry yeast) can be used. The live yeast cells can be added in various ways. For example, live yeast cells can be applied by incorporating a live yeast containing solution into the dough.

The composition of the invention also comprises a yeast extract. Yeast extract is the common name for various forms of processed yeast products made by extracting the cell contents (removing the cell walls); they are used as food additives or flavorings, or as nutrients for bacterial culture media. They are often used to create savory flavors and umami taste sensations, and can be found in a large variety of packaged food including frozen meals, crackers, snack foods, gravy, stock and more. Yeast extracts in liquid form can be dried to a light paste or a dry powder.

Autolyzed yeast (containing the cell walls) or autolyzed yeast extract consist of concentrations of yeast cells that are allowed to die and break up, so that the yeasts' endogenous digestive enzymes break their proteins down into simpler compounds (amino acids and peptides).

The general method for making yeast extract for food products such as Vegemite and Marmite on a commercial scale is to add sodium chloride (salt) to a suspension of yeast, making the solution hypertonic, which leads to the cells shriveling up; this triggers autolysis, in which the yeast self-destructs. The dying yeast cells are then heated to complete their breakdown, after which the husks (yeast with thick cell walls) are separated. Removing the cell walls concentrates the flavors and changes the texture. Preferred yeast extracts include those sold by Lallemand such as its Bio Ingredient Powders including LBI 2131 Powder. We have found that the use of yeast extract increases the speed of fermentation so that the product ferments in 30 to 60 minutes, and preferably in about 30 to 50 minutes. Moreover, the LBI 2131 Powder yeast extract naturally contains enzymes such as protease and amylase, which we have discovered imparts organoleptic properties of pizza on both the dough and final product,

### Sweeteners

The dough and food product of the invention also comprise a sweetener. Depending on the sweetener incorporated into the dough, the sweetener may add to organoleptic properties by providing added bulk or elasticity in the case of natural sugars (aside from the added taste of sweeteners) among other properties. Natural or synthetic (nutritive and nonnutritive) sweeteners may be used in the dough and food product of the invention.

Natural (or nutritive) sweeteners may include sugar as well as sugar salts and derivatives derived from fruits and vegetables including fructose, mannose, sucrose, corn syrup, including high fructose corn syrup, hydrogenated starch, hydrosylates, molasses, chocolate syrup, vegetable syrups such as brown rice syrup, iso malt, malt, maltose, maltitol, glycerol, and mixtures thereof, among others.

Other (nutritive and nonnutritive) sweeteners useful in the dough and food product of the invention may include aspartame, cyclamates, sucralose, stevioside, and saccharin, as well as curculin, erythritol, neotame and mixtures thereof, among others. Combinations of nutritive and nonnutritive sweeteners may also be used if there is a desire for sweetness with a lower calorie value.

One preferred sweetener is brown rice syrup. Brown rice syrup is a sweetener derived by culturing cooked rice starch with saccharifying enzymes to break down the starches, followed by straining off the liquid and reducing it by evaporative heating to the desired consistency. We have found that brown rice syrup provides an ideal source of sugars for the leavening system, aiding in the completion of fermentation within 30 to 60 minutes, as opposed to fermentation times of several hours for traditional pizza dough.

Illustrative concentrations for all ingredients are found in the TABLE 1 below.

TABLE 1
(wt-%)

| Dough | Useful | Preferred | More Preferred |
|---|---|---|---|
| Flour | 40-70 | 50-65 | 57-63 |
| Yeast | 0.5-1.5 | 0.7-1.25 | 0.9-1.1 |
| Yeast Extract | 0.7-2.7 | 1-2.5 | 1.4-1.8 |
| Sweetener | 2.5-7.5 | 3.5-6.5 | 5-5.5 |
| Flavoring | 1.0-3.0 | 1.5-1.75 | 1.8-2.2 |
| Water | q.s. | q.s. | q.s. |

### Method

The snack chips of the invention may be provided by any number of methods known to those of skill in the art. The dough may generally be formulated from hard wheat flour with minimal fat. Once the dough is formulated, it is generally hoppered onto a dry lapping machine and then fed into reduction rollers to provide sheets of appropriate thickness. From that point, the dough is then cut and fed into a chain oven and thermally baked over a series of stations for some length. Optional additional steps including feeding the dough through a laminator and/or a docker.

Representative processes for producing the snack chips and crackers of the invention include those disclosed in U.S. Pat. No. 6,592,923 and U.S. Pat. No. 7,897,191, among others, which are incorporated herein by reference.

### WORKING EXAMPLES

The following examples provide a representative illustration of the invention.

### Example 1

One representative dough formulation may be found below in TABLE 2:

TABLE 2
(wt-%)

| | |
|---|---|
| Yeast (active dry) | 1.01 wt-% |
| Hard Wheat Flour | 61.78 wt-% |
| Sea Salt | 1.01 wt-% |
| Brown Rice Syrup | 5.23 wt-% |
| Yeast Extract | 1.69 wt-% |
| Garlic | 0.34 wt-% |
| Oregano | 0.62 wt-% |
| Water | Q.S. |

### Example 2

A dough is prepared according to the formulation set forth in TABLE 3:

TABLE 3
(wt-%)

| | |
|---|---|
| Yeast (active dry) | 0.97 wt-% |
| Hard Wheat Flour (King) | 60.06 wt-% |
| Sea Salt | 0.97 wt-% |
| Brown Rice Syrup | 5.06 wt-% |
| Yeast Extract (LBI 2131) | 1.64 wt-% |
| Garlic | 0.33 wt-% |
| Oregano | 0.60 wt-% |
| Water | 23.08 wt-% |

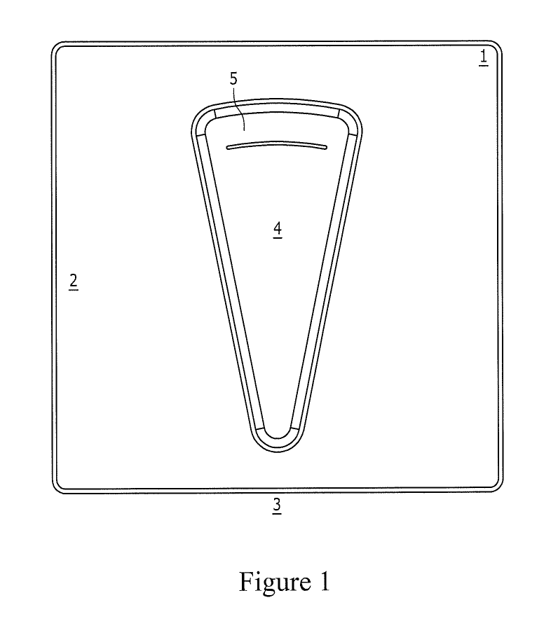

The dough is mixed for about 8 to 12 minutes, preferably for 9 minutes. The dough is then allowed to ferment for a period of about 30-60 minutes, preferably 30 minutes. Subsequently, the dough is fed into a hopper which deposits the dough onto a dry lapper machine. The dough is then fed to reduction rollers to provide sheets of appropriate thickness. From this point, the dough is cut into desired shapes. An example of a die utilized in the cutting device is disclosed in FIG. 1. As FIG. 1 shows, the die 1 is square shaped and has a length 2 of about four inches and a width 3 of about four inches. The die stamp 4 is of a wedge or conical shape, including a curved interior ridge 5. The die cuts the dough such that it resembles a miniature pizza slice. The curved interior ridge 5 creates the impression of a pizza crust on the dough. The die 1 may be manufactured of any material suitable for food production, including Lexan™ polycarbonate or other food grade plastics, as well as food grade metals such as aluminum or stainless steel.

Finally, after the dough is cut it is fed into a chain oven, where it is thermally baked over a series of stations at a temperature varying between 360° F. to 555° F. In one example, the dough is fed into a chain oven containing five zones with varying temperatures as set forth in Table 4:

TABLE 4

| Oven Zone | Top Temperature | Bottom Temperature |
|---|---|---|
| Zone 1 | 380° F.-395° F. | 410° F. |
| Zone 2 | 430° F.-465° F. | 470° F. |
| Zone 3 | 555° F. | 540° F. |
| Zone 4 | 520° F. | 485° F. |
| Zone 5 | 360° F.-410° F. | 450° F. |

Optional steps may also include feeding the dough through a laminator and/or a docker.

Throughout the mixing to baking process, the pH of the dough remains in the range of 4.5-6.5. After baking, the product formed from the dough has a thickness between 2.25 cm to 2.5 cm, or 2.25 mm to 2.5 mm and a width of 1.5 cm to 1.8 cm, or 1.5 mm to 1.8 mm. The product is subsequently topped with a mixture of roasted garlic and salt (comprising 3.06 wt-% of the pre-baked dough), as well as canola oil (comprising 4.22 wt-% of the pre-baked dough).

Although the invention has been described by reference to its preferred embodiment as is disclosed in the specification and drawings above, many more embodiments of the invention are possible without departing from the invention. Thus, the scope of the invention should be limited only by the appended claims.

The claimed invention is:

1. A composition comprising a dough, said dough further comprising:
a. a flour;
b. a leavening system comprising yeast and a yeast extract; and
c. a sweetener;
wherein said dough displays the organoleptic properties of pizza dough and has a fermentation time of about 30-60 minutes.

2. The composition of claim 1, wherein said dough further comprises a flavoring and water.

3. A food product resulting from the dough of claim 1 or 2.

4. The composition of claim 1 or 2, wherein said flour further comprises a hard wheat flour.

5. The composition of claim 4, wherein said hard wheat flour comprises about 10% to 15% protein.

6. The composition of claim 4, wherein said hard wheat flour comprises about 13% to 15% protein.

7. The composition of claim 1 or 2, wherein said yeast is selected from the group consisting of wine yeast strains, beer yeast strains, baker's yeast strains, probiotic yeast strains and mixtures thereof.

8. The composition of claim 1 or 2, wherein said yeast extract is LBI 2131 Powder.

9. The composition of claim 1 or 2, wherein said sweetener is brown rice syrup.

10. The composition of claim 1 or 2, wherein said sweetener is selected from the group consisting of fructose, mannose, sucrose, corn syrup, high fructose corn syrup, hydrogenated starch, hydrosylates, molasses, chocolate syrup, vegetable syrups, iso malt, malt, maltose, maltitol, glycerol and mixtures thereof.

11. The composition of claim 1 or 2, wherein said sweetener is selected from the group consisting of aspartame, cyclamates, sucralose, stevioside, saccharin, curculin, erythritol, neotame and mixtures thereof.

12. The composition of claim 2, wherein said flavoring is selected from the group consisting of sea salt, garlic, oregano, cooking oil and mixtures thereof.

13. The composition of claim 2, wherein:
a. said flour comprises about 40-70 wt-% of said dough;
b. said yeast comprises about 0.5-1.5 wt-% of said dough;
c. said yeast extract comprises about 0.7-2.7 wt-% of said dough;
d. said sweetener comprises about 2.5-7.5 wt-% of said dough; and
e. said flavoring comprises about 1.0-3.0 wt-% of said dough.

14. The composition of claim 2, wherein:
a. said flour comprises about 50-65 wt-% of said dough;
b. said yeast comprises about 0.7-1.25 wt-% of said dough;
c. said yeast extract comprises about 1.0-2.5 wt-% of said dough;
d. said sweetener comprises about 3.5-6.5 wt-% of said dough; and
e. said flavoring comprises about 1.5-1.75 wt-% of said dough.

15. The composition of claim 2, wherein:
a. said flour comprises about 57-63 wt-% of said dough;
b. said yeast comprises about 0.9-1.1 wt-% of said dough;
c. said yeast extract comprises about 1.4-1.8 wt-% of said dough;
d. said sweetener comprises about 5.0-5.5 wt-% of said dough; and
e. said flavoring comprises about 1.8-2.2 wt-% of said dough.

16. A method of preparing a fermented dough snack with the organoleptic properties of pizza, said method comprising the steps of:
a. Mixing ingredients to form a dough, said ingredients comprising
40-70 wt-% flour;
0.5-1.5 wt-% yeast;
0.7-2.7 wt-% yeast extract;
2.5-7.5 wt-% sweetener; and
1.0-3,0 wt-% first flavoring;
b. Fermenting said dough for about 30-60 minutes;
c. Dry lapping said dough;
d. Reducing said dough to an appropriate thickness
e. Cutting said dough into desired shapes; and
f. Baking said dough at a temperature between 360° F. to 555° F.

17. The method of claim 16, further comprising the step of topping said dough with a second flavoring after said baking step is complete.
